(19) United States
(12) Patent Application Publication
(10) Pub. No.: US 2024/0210519 A1
(43) Pub. Date: Jun. 27, 2024

(54) SOUND-BASED LOCATION DETECTION FOR ELECTRONIC DEVICES

(71) Applicant: Apple Inc., Cupertino, CA (US)

(72) Inventors: Jian YU, Mountain View, CA (US); Alessandro TOSO, San Jose, CA (US); Andrew L. DOYLE, San Francisco, CA (US); David W. ROBISON, San Jose, CA (US); Joyce E. GORNY, Fort Lee, NJ (US); Prateek MURGAI, Cupertino, CA (US)

(21) Appl. No.: 18/501,971

(22) Filed: Nov. 3, 2023

Related U.S. Application Data
(60) Provisional application No. 63/435,218, filed on Dec. 23, 2022.

(51) Int. Cl. G01S 5/26; G06F 3/16; H04R 1/02; H04R 1/40; H04R 3/00

(52) U.S. Cl. CPC G01S 5/26; G06F 3/16; H04R 1/028; H04R 1/406; H04R 3/005; H04R 2499/15

(57) ABSTRACT

Aspects of the subject technology relate to determining a location of a device using sound that is output from the device. For example, an audio output from one or more speakers of an electronic device may be received at one or more microphones of another electronic device, and used by the other electronic device to determine the location of the electronic device.

### CROSS REFERENCE TO RELATED APPLICATIONS

This application claims the benefit of priority to U.S. Provisional Patent Application No. 63/435,218, entitled, “Content Sharing Using Sound-Based Locations of Electronic Devices”, filed on Dec. 23, 2022, the disclosure of which is hereby incorporated herein in its entirety.

### TECHNICAL FIELD

The present description relates generally to acoustic devices including, for example, content sharing using sound-based locations of electronic devices.

### BACKGROUND

Electronic devices often include geolocation circuitry, such as Global Positioning System (GPS) circuitry by which the device can determine its own location.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates a perspective view of a first example electronic device and a second example electronic device in accordance with various aspects of the subject technology.

FIG. 2 illustrates a schematic diagram of an electronic device providing one or more audio outputs from multiple speakers that are received by a microphone of another electronic device in accordance with various aspects of the subject technology.

FIG. 3 illustrates a schematic diagram of an electronic device providing an audio output from a speaker that is received by multiple microphones of another electronic device in accordance with various aspects of the subject technology.

FIG. 4 illustrates a schematic diagram of an electronic device providing one or more audio outputs from multiple speakers that are received by multiple microphones of another electronic device in accordance with various aspects of the subject technology.

FIG. 5 illustrates a schematic diagram of an electronic device providing an audio output, and time synchronization information for the audio output, to another electronic device in accordance with various aspects of the subject technology.

FIG. 6 illustrates a schematic diagram of an electronic device providing an audio output including encoded location information to another electronic device in accordance with various aspects of the subject technology.

FIG. 7 illustrates aspects of an example use case in which a location of an electronic device is determined based on an audio output and time synchronization information for the audio output in accordance with various aspects of the subject technology.

FIG. 8 illustrates aspects of an example use case in which a visual indicator of a direction to an electronic device is provided in accordance with various aspects of the subject technology.

FIG. 9 illustrates aspects of an example use case in which a location of an electronic device is determined, based on an audio output, and used for synchronizing display content in accordance with various aspects of the subject technology.

FIG. 10 illustrates a flow chart of illustrative operations that may be performed for determining a location of a device using an audio output from the device in accordance with various aspects of the subject technology.

FIG. 11 illustrates a flow chart of illustrative operations that may be performed for encoding a location of a device in an audio output from the device in accordance with various aspects of the subject technology.

FIG. 12 illustrates a flow chart of illustrative operations that may be performed for displaying display content from a first device at a second device using a location determined using an audio output from first device in accordance with various aspects of the subject technology.

FIG. 13 illustrates a flow chart of illustrative operations that may be performed for displaying display content from a first device at a second device using location information generated by the first device based on an audio output from the second device in accordance with various aspects of the subject technology.

FIG. 14 illustrates a flow chart of illustrative operations that may be performed for providing content from a device to another device based on a location determined using an audio output from the other device in accordance with various aspects of the subject technology.

FIG. 15 illustrates a flow chart of illustrative operations that may be performed for providing display content from a first device for display at a second device in accordance with various aspects of the subject technology.

FIG. 16 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In accordance with aspects of the subject technology, sound-based location detection for electronic devices is provided. As described in further detail hereinafter, in various examples, sound-based location detection of electronic devices can provide for locating a misplaced device using an audio output from the misplaced device, locating a device of a user that is lost or in distress, locating a device having a display for content sharing such as extended display operations, or locating a device for content sharing such as directional transmission of content or other data.

As described in further detail hereinafter, in various implementations, a device that is emitting an audio output can be located by a receiving device using multiple microphones of the receiving device, multiple audio outputs from multiple speakers of the emitting device, using time synchronization information provided along with the audio output, and/or using location information encoded into the audio output.

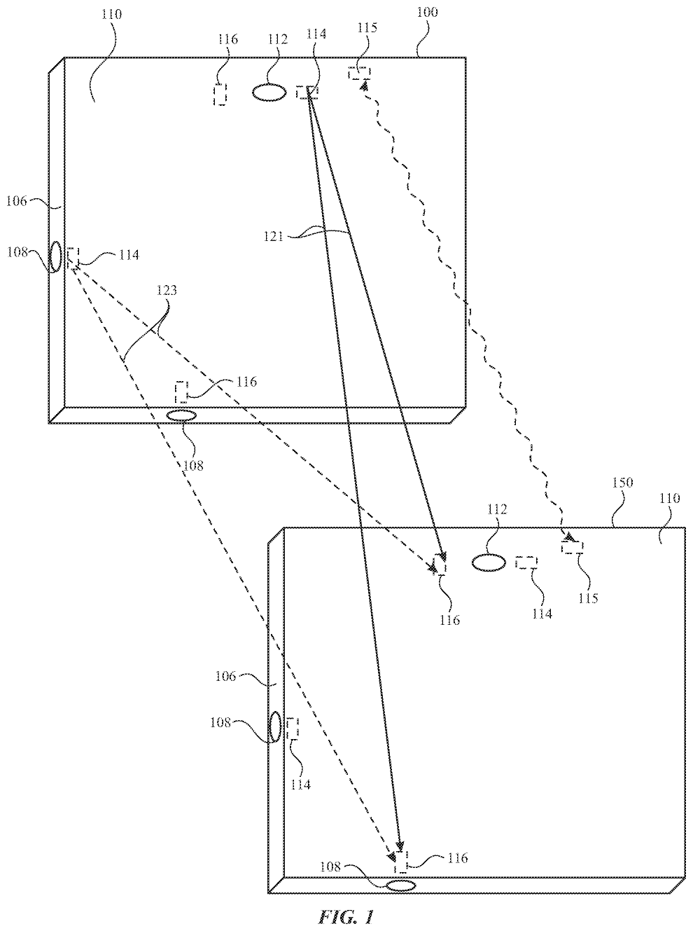

Illustrative electronic devices are shown in FIG. 1. In the example of FIG. 1, electronic device 100 has been implemented using a housing that is sufficiently small to be portable and carried or worn by a user (e.g., electronic device 100 of FIG. 1 may be a handheld electronic device such as a tablet computer or a cellular telephone or smart phone, or a wearable device such as a smart watch, a pendant device, a headlamp device or other head mountable device, headphones, earbuds, or the like). In the example of FIG. 1, electronic device 100 includes a display such as display 110 mounted on the front of a housing 106. Electronic device 100 may include one or more input/output devices such as a touch screen incorporated into display 110, a button, a switch, a dial, a crown, and/or other input output components disposed on or behind display 110 or on or behind other portions of housing 106. Display 110 and/or housing 106 may include one or more openings to accommodate a button, a speaker, a light source, or a camera (as examples).

In the example of FIG. 1, housing 106 includes openings 108. For example, openings 108 may form one or more ports for an audio component. In the example of FIG. 1, one of the openings 108 forms a speaker port for a speaker 114 disposed within the housing 106, and another of the openings 108 forms a microphone port for a microphone 116 disposed within the housing. In this example, one of the speakers 114 is aligned with a corresponding opening 108 to project sound through a corresponding opening 108, and one of the microphones 116 is aligned with another corresponding opening 108 to receive sound through the corresponding opening. In other implementations, a speaker 114 and/or a microphone 116 may be offset from a corresponding opening 108, and sound may be routed through the corresponding opening 108 from the speaker 114 or to the microphone 116 by one or more internal device structures.

A speaker 114 may be configured to output audio in a human audible range (e.g., audio having one or more frequencies between approximately twenty Hertz and twenty kilohertz (kHz), and/or audio in an ultrasonic frequency range (e.g., audio having one or more frequencies above twenty kHz). For example, a speaker 114 may be operated (e.g., by a processor of the electronic device 100 or a processor of the electronic device 150) to output audio content in the human audible range for audio consumption by a user, such as music, spoken voice (e.g., recorded poetry, or livestreaming audio as part of a telephone call or audio or video conference) podcasts, audio content associated with video content. In one or more implementations, a speaker 114 that is configured to output audio content in the human audible range for audio consumption by a user may be operated (e.g., concurrently or at a different time) to output audio at one or more ultrasonic frequencies. A microphone 116 may be configured to detect audio in a human audible range (e.g., audio having one or more frequencies between approximately twenty Hertz and twenty kilohertz (kHz), and/or audio in an ultrasonic frequency range (e.g., audio having one or more frequencies above twenty kHz). For example, a microphone 116 may be operated (e.g., by a processor of the electronic device 100 or a processor of the electronic device 150) to generate microphone signals responsive to audio input received at the microphone in the human audible range, such as a voice of a person (e.g., a user of the electronic device or another person, such as for operation of a voice call application, a video conferencing application, an audio conferencing application, a recording application, a voice-assistant application, or any other application that operates based on audio inputs to the electronic device that includes the microphone). In one or more implementations, a microphone 116 that is configured to receive audio content in the human audible range may be operated (e.g., concurrently or at a different time) to receive audio (e.g., from another electronic device for locating the other electronic device) at one or more ultrasonic frequencies.

In the example of FIG. 1, display 110 also includes an opening 112. For example, opening 112 may form a port for one or more audio components. In the example of FIG. 1, the opening 112 forms a speaker port for a speaker 114 disposed within the housing 106 and behind a portion of the display 110, and a microphone port for a microphone 116 disposed within the housing 106 and behind a portion of the display 110. In this example, the speaker 114 and the microphone 116 are offset from the opening 112. In this example, sound from the speaker may be routed to and through the opening 112 by one or more device structures. In this example, sound from the external environment of the electronic device may be routed from the opening 112 to the microphone 116 by one or more device structures. In other implementations, the speaker 114 may be aligned with a corresponding opening 108 or opening 112.

As shown in FIG. 1, electronic device 100 may include communications circuitry 115. Communications circuitry 115 may include WiFi communications circuitry, Bluetooth communications circuitry, near-field communications circuitry, Global Positioning System (GPS) communications circuitry, and/or other communications circuitry for communication with other electronic devices and/or servers directly and/or over one or more networks including local area networks and/or wider area networks including the Internet.

In various implementations, the housing 106 and/or the display 110 may also include other openings, such as openings for one or more microphones, one or more pressure sensors, one or more light sources, or other components that receive or provide signals from or to the environment external to the housing 106. Openings such as opening 108 and/or opening 112 may be open ports or may be completely or partially covered with a permeable membrane or a mesh structure that allows air and/or sound to pass through the openings. Although two openings (e.g., opening 108 and opening 112) are shown in FIG. 1, this is merely illustrative. One opening 108, two openings 108, or more than two openings 108 may be provided on the one or more sidewalls of the housing 106, on a rear surface of housing 106 and/or a front surface of housing 106. One opening 112, two openings 112, or more than two openings 112 may be provided in the display 110. In some implementations, one or more groups of openings in housing 106 and/or groups of openings 112 in display 110 may be aligned with a single port of an audio component within housing 106. Housing 106, which may sometimes be referred to as a case, may be formed of plastic, glass, ceramics, fiber composites, metal (e.g., stainless steel, aluminum, etc.), other suitable materials, or a combination of any two or more of these materials.

The configuration of electronic device 100 of FIG. 1 is merely illustrative. In other implementations, electronic device 100 may be a computer such as a computer that is integrated into a display such as a computer monitor, a laptop computer, a media player, a gaming device, a navigation device, a computer monitor, a television, a headphone, an earbud, or other electronic equipment. In some implementations, electronic device 100 may be provided in the form of a wearable device such as a smart watch. In one or more implementations, housing 106 may include one or more interfaces for mechanically coupling housing 106 to a strap or other structure for securing housing 106 to a wearer.

As shown in FIG. 1, another electronic device, such as electronic device 150 may also include one or more components, such as a housing 106, a display 110, one or more speakers 114, one or more microphones 116, and communications circuitry 115. In the example of FIG. 1, the electronic device 100 and the electronic device 150 have the same form factor. For example, the speakers 114 and the microphones 116 of the electronic device 150 may be aligned with or disposed near respective openings 108 in the housing 106 of the electronic device 150 and/or openings 112 in the display 110 of the electronic device 150. In one or more implementations, the electronic device 100 and the electronic device 150 may be implemented as smart watches, other wearable devices, smart phones, tablets, or the like. However, this is merely illustrative and, in other implementations, the electronic device 100 and the electronic device 150 may be implemented with different form factors (e.g., the electronic device 100 may be implemented as a laptop computer or a desktop computer, and the electronic device 150 may be implemented as a tablet device, a smart phone, or other device having a display or the electronic device 150 may be implemented as a laptop computer or a desktop computer, and the electronic device 100 may be implemented as a tablet device, a smart phone, or other device having a display).

In the example of FIG. 1, the electronic device 100 and the electronic device 150 are each shown as having two microphones and two speakers. However, this is merely illustrative, and either or both of the electronic device 100 or the electronic device 150 may include one speaker, two speakers, three speakers, four speakers, or more than four speakers and/or one microphone, two microphones, three microphones, four microphones, or more than four microphones. In various use cases, two or more speakers of the electronic device 100 may be operated independently or cooperatively (e.g., as a beamforming speaker array). In various use cases, two or more speakers of the electronic device 150 may be operated independently or cooperatively (e.g., as a beamforming speaker array). In various use cases, two or more microphones of the electronic device 100 may be operated independently or cooperatively (e.g., as a beamforming microphone array). In various use cases, two or more microphones of the electronic device 150 may be operated independently or cooperatively (e.g., as a beamforming microphone array).

As shown in FIG. 1, in one or more use cases, the electronic device 100 may output audio (e.g., by generating sound including audio content) from one or more of the speakers 114. The audio output may be audible to human users, and/or may include ultrasonic audio that is inaudible to human users. As shown, audio outputs 121 and 123 from each of the speaker(s) 114 of the electronic device 100 may be received at each of the microphone(s) 116 of the electronic device 150. As discussed in further detail hereinafter, the electronic device 150 may determine the location of the electronic device 100 (e.g., the location relative to the location of the electronic device 150, including a distance from the electronic device 150 and/or an angular location of the electronic device 100 relative to the electronic device 150) using the audio outputs 121 and/or 123 from the speakers 114 of the electronic device 100 as received at the microphone(s) 116 of the electronic device 150. In the example of FIG. 1, the audio output from the electronic device 100 is indicated using arrows in the direction of the microphones 116 of the electronic device 150. However, this is merely illustrative, and the audio output(s) from the speaker(s) 114 of the electronic device 100 may be emitted in a spherical pattern, a hemispherical pattern, another non-directional pattern, or may be directed in one or more particular directions using beamforming or other directional audio emission techniques or structures.

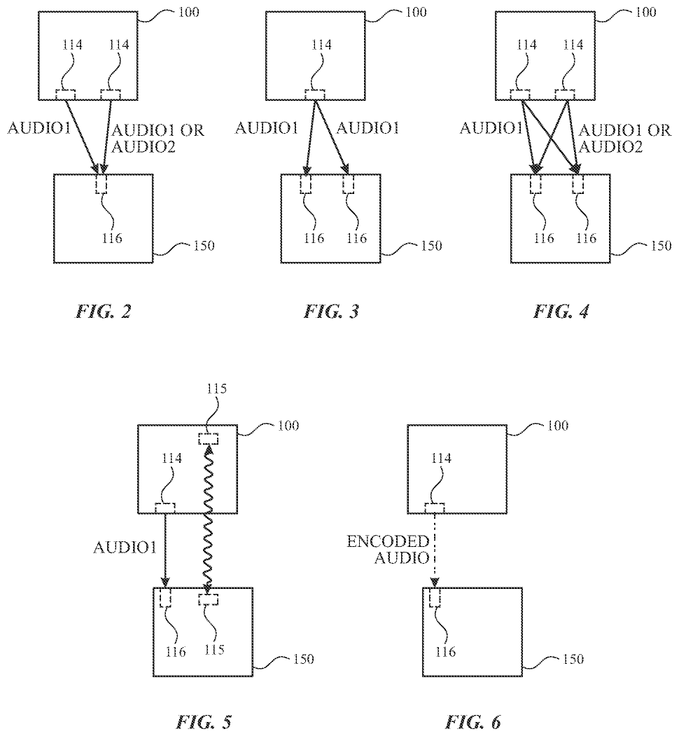

As illustrated in FIGS. 2-6, in various implementations and/or use cases, the electronic device 100 can be located by the electronic device 150 using multiple audio outputs from multiple speakers 114 of the electronic device 100, using multiple microphones 116 to receive an audio output from the electronic device 100, using multiple microphones 116 to receive multiple audio outputs from multiple speakers 114 of the electronic device 100, using time synchronization information provided along with the audio output, and/or using location information encoded into the audio output.

For example, FIG. 2 illustrates a use case in which audio outputs from two (or more) speakers 114 of the electronic device 100 may be received by a microphone 116 of the electronic device 150. Because the two (or more) speakers 114 are spatially separated from each other on or within the electronic device 100, the speakers 114 of the electronic device 100 are located at different respective distances from the microphone 116 of the electronic device 150. Accordingly, the audio that is output from the various speakers 114 of the electronic device 100 will arrive at the microphone 116 at different times and/or with different amplitudes. These different times and/or different amplitudes can be used (e.g., along with the known spatial arrangement of the speakers 114, and/or known audio content in the audio outputs, which may have been previously provided to the electronic device 150) to compute a distance between the electronic device 100 and the electronic device 150 and/or an angular position of the electronic device 100 with respect to the electronic device 150.

In various use cases, in order (for example) to facilitate distinguishing of the multiple audio outputs from multiple speakers of the electronic device 100, the electronic device 100 may emit the same audio content (e.g., AUDIO1) from the two (or more) speakers at two (or more) different (e.g., predetermined) times (e.g., a first one of the speakers 114 may emit the audio output at a first time and/or a cadence and a second one of the speakers 114 may emit the audio output at a second time or cadence that is offset from the first time or cadence by an offset time that is known to the electronic device 150 and/or a second frequency that is different from the first frequency) or may emit different audio content (e.g., AUDIO1 and AUDIO2, such as different patterns and/or different frequencies of sound) from different speakers 114. The content of the audio output (e.g., the emitted audio content) may include a patterned audio output, such as a series of chirps having predetermined durations, amplitudes, frequencies, and/or spacings between the chirps. Information indicating the predetermined durations, amplitudes, cadences, frequencies, and/or spacings between the chirps may have been previously provided to and/or stored at the electronic device 150 to be used to determine the location of the electronic device 100 from the audio output(s).

As shown in FIG. 3, in one or more other use cases, an audio output (e.g., AUDIO1) from a single speaker 114 of the electronic device 100 may be received by two (or more) microphones 116 of the electronic device 150. Because the two (or more) microphones 116 are spatially separated from each other on or within the electronic device 150, the microphones 116 of the electronic device 150 are located at different respective distances from the speaker 114 of the electronic device 100. Accordingly, portions of the audio that is output from the speaker 114 of the electronic device 100 will arrive at the different microphones 116 of the electronic device 150 at different times and/or with different amplitudes. These different times and/or different amplitudes of the received portions of the audio output can be used (e.g., along with the known spatial arrangement of the microphones 116) to compute a distance between the electronic device 100 and the electronic device 150 and/or an angular position of the electronic device 100 with respect to the electronic device 150.

As shown in FIG. 4, in one or more other use cases, one or more audio outputs from two or more speakers 114 of the electronic device 100 may be received by two or more microphones 116 of the electronic device 150, and used by the electronic device 150 to determine the location (e.g., relative to the electronic device 150). As shown in FIG. 5, in one or more other use cases, an audio output from one or more speakers 114 of the electronic device 100 received by one or more microphones 116 of the electronic device 150 in conjunction with time synchronization information for the audio output. The time synchronization information may be transmitted from the electronic device 100 using the communications circuitry 115 of the electronic device 100 and received by the communications circuitry 115 of the electronic device 150. The distance of the electronic device 100 from the electronic device 150 may then be determined, by the electronic device 150, using the audio output as received by the microphone(s) 116 and using the time synchronization information for the audio output (e.g., as discussed in further detail hereinafter in connection with FIG. 7).

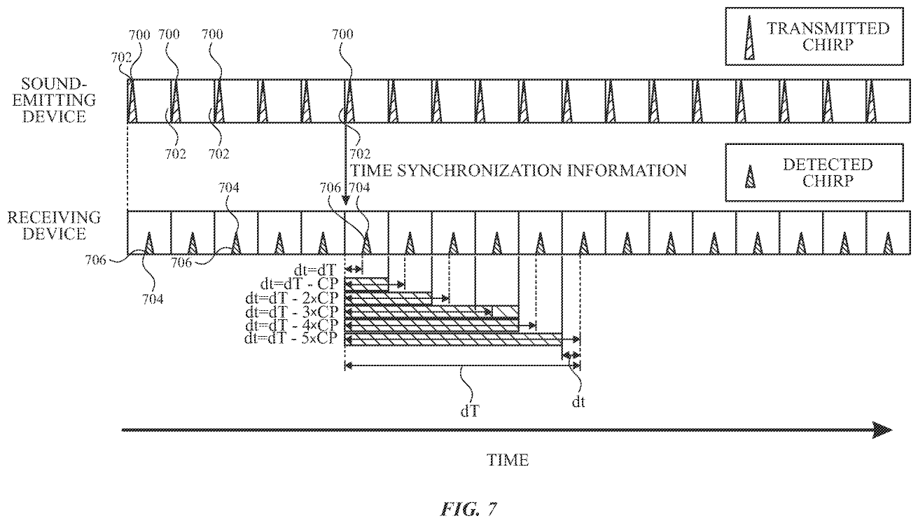

As shown in FIG. 6, in one or more use cases, the audio that is output from one or more speaker(s) 114 of the electronic device 100 and received by one or more microphone(s) 116 of the electronic device 150 may be or include encoded audio content that encodes the location of the electronic device 100. For example, the electronic device 100 may determine its own location (e.g., using communications circuitry 115 to communicate with a Global Positioning System server or satellite), and may encode some or all of the location in the audio output.

In one illustrative example, the electronic device 100 may determine its own location in degrees, minutes, and seconds, of longitude and or latitude. However, since the electronic device 150 (and/or any other electronic devices that may receive the audio output from the speaker 114 of the electronic device 100), will be within an audible range of the audio output at the time that the audio output is received at the electronic device 150 (and/or other electronic devices that receive the audio output), the electronic device 100 may only encode a local portion of the location of the electronic device 100 in the audio output. For example, in one or more use cases, the entire audible range of the audio output from the speaker 114 may be disposed within a region defined by the degrees and minutes of the latitude and longitude of the electronic device 100. Accordingly, it may be unnecessary to provide the degrees and minutes of the latitude and longitude of the electronic device 100 to another electronic device that is located within a region having the same degrees and minutes of latitude and longitude. Accordingly, in one example, the electronic device 100 may encode only the seconds of latitude and longitude in the audio output from the speaker 114. This may improve the efficiency and reduce power and/or computing resource consumption by the encoding electronic device, which can be beneficial particularly, for example, in a battery powered and/or compact device in which power and/or computing resources are limited.

The location information of the electronic device 100 can be encoded into an audio output from a speaker 114 in various ways. For example, the local portion (e.g., the seconds of latitude and longitude) of the location of the electronic device 100 can be translated into Morse code or another coded language that can be encoded into modulations of amplitude, frequency, phase, and/or patterns of sound, and the Morse coded audio (or other coded audio) corresponding to the local portion of the location can be output from the speaker 114.

In some implementations and/or use cases, the electronic device 100 may have other constraints on the output of the speaker 114. For example, in one or more use cases, the output of from the speaker 114 may be designed as an audio distress signal that indicates a user of the electronic device 100 may be lost or in distress. An audio distress signal may have a frequency, a tone, a chirp pattern, or other aspects or features that are designed to be maximally audible to a human listener or another electronic device, and/or may be designed with a frequency or tone that corresponds to one or more resonant frequencies of the electronic device 100 (e.g., to maximize loudness of the output while reducing power usage). Accordingly, in some implementations, it may be desirable to encode some or all of the location of the electronic device 100 into the audio output from the speaker 114, without modifying one or more of the frequency, tone, chirp pattern, or other aspects of the audio output.

In one illustrative example, the audio output from the speaker 114 may consist of a pattern of chirps (e.g., short bursts of sound that are separated from each other in time) that are emitted at frequencies corresponding to one or more resonant frequencies of the electronic device 100. In this illustrative example, it may be undesirable to change the frequencies of the chirps in order to encode the location information. Accordingly, in this illustrative example, the location information may be encoded in the audio output by modifying the times at which the chirps are emitted. That is, in this illustrative example, the electronic device 150 may determine the location of the electronic device 100 by extracting location information for the location of the electronic device 100 from the relative arrival times of the chirps and/or the amounts of time between several of the emitted chirps of the audio output of the speaker 114 of the electronic device 100. In various implementations, the encoded location information may be repeated with multiple repeated chirp patterns, or may be encoded across multiple repeating chirp patterns.

Although the example of FIGS. 1-6 show the electronic device 100 emitting audio output that is received at the electronic device 150 for locating of the electronic device 100 by the electronic device 150, it is appreciated that in other use cases, the electronic device 150 may emit audio output that is received at the electronic device 100 for locating of the electronic device 150 by the electronic device 100, and/or the electronic device 150 and/or the electronic device 150 may be located by another device using sound emitted by the electronic device 100, and/or the electronic device 150.

FIG. 7 illustrates additional details of a use case in which time synchronization information is provided along with an audio output. As shown in FIG. 7, a sound-emitting device (e.g., the electronic device 100 or the electronic device 150) may emit a series of emitted chirps 700 at a corresponding series of emission times 702. Due to the distance between the sound-emitting device and a receiving device (e.g., the other of the electronic device 100 or electronic device 150), the receiving device may receive a series of received chirps 704 that are smaller in amplitude than the emitted chirps 700 (as only a portion of the emitted chirps 700 may be received at the receiving device) and that arrive at the receiving device at a series of corresponding times 706 that are offset from the emission times 702 (e.g., by an amount corresponding to the speed of sound, C, multiplied by the distance to the sound-emitting device).

As illustrated in FIG. 7, using the time synchronization information received from the sound-emitting device, the receiving device can determine the emission time of each chirp, determine an offset time, dt, for that chirp (e.g., an amount of time between the emission time 702 of the emitted chirp 700 and the time 706 of the arrival of the corresponding received chirp 704), and determine the distance to the sound-emitting device (e.g., by multiplying the determined offset by the speed of sound, C). As indicated in FIG. 7, multiple offsets for multiple chirps can be used to determine several estimated distances, which can be combined (e.g., averaged or median-ed) to obtain the distance to the sound-emitting device.

Whether or not time synchronization information is provided to the receiving device, the emitted chirps 700 of FIG. 7 also show aspects of an audio output that can be modified, such as to encode location information for the sound-emitting device into the audio output from the sound-emitting device. As examples, the amplitudes of the emitted chirps 700 can be modified to encode location information, the widths (in time) of the emitted chirps 700 can be modified to encode location information, the envelopes of the emitted chirps 700 can be modified to encode location information, and/or the emission times 702 can be modified to encode location information.

Whether the location of the electronic device 100 is determined based on an audio output from the electronic device 100 using multiple speaker outputs (see, e.g., FIGS. 2 and 4), multiple microphone inputs (see, e.g., FIGS. 3 and 4), time synchronization information (see, e.g., FIGS. 5 and 7), and/or encoded location information (see, e.g., FIG. 6), the electronic device 150 may utilize the determined location of the electronic device 100 in various ways, any or all of which may improve the functioning of the electronic device 100.

For example, FIG. 8 illustrates an example in which the electronic device 150 determines, based on an audio output 800 from the electronic device 100, a location of the electronic device 100, and provides, for display at the electronic device 150 (e.g., on the display 110 of the electronic device 150), a visual indicator 802 of a direction from the electronic device 150 to the location of the electronic device 100. As the electronic device 150 is moved relative to the electronic device 100, the electronic device 150 may update the location of the electronic device 100 relative to the electronic device 150 and correspondingly update the visual indicator 802 to indicate the direction to the electronic device 100 (e.g., by rotating the arrow to point toward the location of the electronic device 100 and/or increasing or decreasing a size of the arrow to indicate an increasing or decreasing distance to the electronic device 100).

Although the visual indicator 802 is shown as an arrow in FIG. 8, this is merely illustrative, and any other visual indicator that can indicate a direction can be used to indicate the direction to the location of the electronic device 100. In one or more implementations, other indicators, such audio indicators (e.g., voice output including spoken directions, or a series of beeps or taps that increase in frequency and/or amplitude when the electronic device 150 is moved closer to the electronic device 100 and/or decrease in frequency and/or amplitude when the electronic device 150 is moved away from the electronic device 100) and/or tactile indicators (e.g., a series of taps or clicks that increase in frequency and/or amplitude when the electronic device 150 is moved closer to the electronic device 100 and/or decrease in frequency and/or amplitude when the electronic device 150 is moved away from the electronic device 100) can be provided by the electronic device 150 to indicate the direction to the location of the electronic device 100.

In one or more implementations, the visual indicator 802 of FIG. 8 can be used to locate the electronic device 100 when a user of the electronic device 100 and the electronic device 150 has misplaced the electronic device 100, and has access to the electronic device 150. For example, the user of the electronic device 150 may provide a user request to the electronic device 150 to locate the electronic device 100. Responsive to the user request, the electronic device 150 may send a trigger signal (e.g., using communications circuitry 115) to instruct the electronic device 100 to emit a sound that can be used to locate the electronic device 100. The electronic device 150 may then determine the location of the electronic device 100 using a received portion of the sound from the electronic device, and may provide the visual indicator 802 based on the determined location.

In one or more implementations, the visual indicator 802 of FIG. 8 can be used to locate a user of the electronic device 100 that is lost or in distress. For example, the user of the electronic device 100 that is lost or in distress can initiate output of a distress sound that can be used by the electronic device 150 to locate the electronic device, as described herein. As another example, the electronic device 100 can detect a fall, a crash, or other event that may cause the user of the electronic device 100 to be disabled or otherwise distressed, and may automatically initiate output of the distress sound that can be used by the electronic device 150 to locate the electronic device, as described herein.

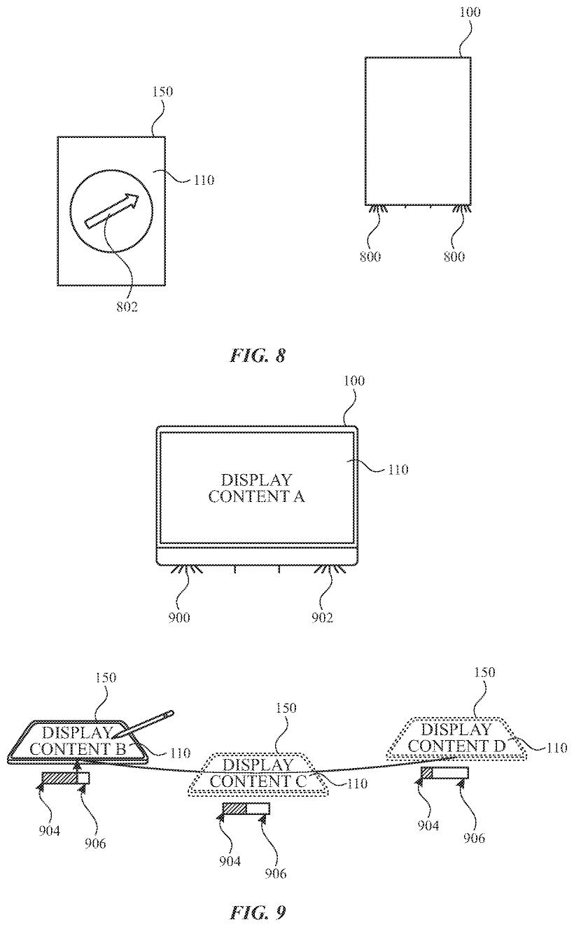

FIG. 9 illustrates an example use case in which an audio output from an electronic device is used to spatially synchronize display content at the electronic device and another electronic device. For example, as shown in FIG. 9, the electronic device 100 (e.g., implemented as a desktop or a laptop computer in this example) may show first display content (e.g., display content A) on the display 110 of the electronic device, and the electronic device 150 may display corresponding second display content (e.g., display content B, display content C, or display content D) depending on the location of the electronic device 150 relative to the electronic device 100. For example, the first display content (e.g., display content A) may be a portion of a desktop view of an operating system running on the electronic device 100. The second display content (e.g., display content B, display content C, or display content D) that is displayed at the electronic device 150 may be an extended portion of the desktop view of the electronic device 100.

In this example, in order to determine which portion of the desktop view of the electronic device 100 is displayed at the electronic device 100 and which portion of the desktop view of the electronic device 100 is displayed at the electronic device 150, the electronic device 100 and/or the electronic device 150 determines the location of the electronic device 100 relative to the location of the electronic device 150. In the example of FIG. 9, the electronic device 100 outputs a first audio output 900 from a first speaker (e.g., a speaker 114, such as a left speaker) and a second audio output from a second speaker (e.g., a speaker 114, such as a right speaker). As indicated in the figure, in a use case in which the electronic device 150 is disposed to the left of the electronic device 150, the electronic device 150 (e.g., one or more microphones 116 of the electronic device 150) receives a received portion 904 of the first audio output 900 at an earlier time and/or a larger amplitude than a received portion 906 of the second audio output 902. As indicated in the figure, in a use case in which the electronic device 150 is disposed to the right of the electronic device 150, the electronic device 150 (e.g., one or more microphones 116 of the electronic device 150) receives a received portion 904 of the first audio output 900 at an later time and/or a smaller amplitude than a received portion 906 of the second audio output 902. As indicated in the figure, in a use case in which the electronic device 150 is disposed at a location between the speakers of the electronic device 150, the electronic device 150 (e.g., one or more microphones 116 of the electronic device 150) receives a received portion 904 of the first audio output 900 at the same time, and with the same amplitude as a received portion 906 of the second audio output 902. So that the electronic device 100 can distinguish between the first audio output 900 and the second audio output 902, the first audio output 900 and the second audio output 902 include different audio content (e.g., different chirp styles and/or patterns), or may be emitted at different predetermined times).

Accordingly, in this example, the electronic device 150 can determine an angular location of the electronic device 100 relative to the location of the electronic device 150 using the first audio output 900 and the second audio output 902. In one or more implementations, the electronic device 150 may transmit (e.g., using communications circuitry 115) the relative location determined based on the audio output from the electronic device 100 back to the electronic device 100, and the electronic device 100 may provide the display content A, display content B, or display content C to the electronic device 150 for display at the electronic device 150 based on the received relative location. In one or more other implementations, the electronic device 150 may receive the entire desktop view of the electronic device 100, and may determine locally which portion of the desktop view to display at the electronic device 150 (based on the determined location). The electronic device 100 may also adjust the display content A displayed at the electronic device 100 based on the received relative location.

In the example of FIG. 9, the electronic device 150 determines the relative location based on the audio output from the electronic device 100. However, as discussed herein in connection with FIGS. 2-6, in other implementations, the electronic device 100 may also, or alternatively, determine the relative location based on one or more audio outputs from the electronic device 150.

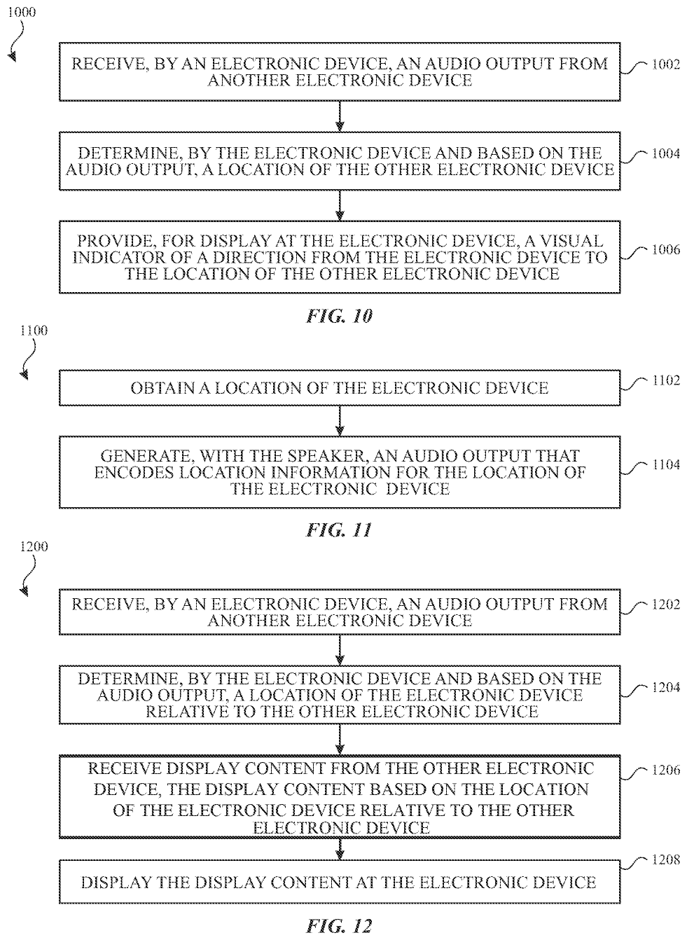

FIG. 10 illustrates a flow diagram of an example process for providing a visual indicator of a direction to a device using an audio output from the device, in accordance with one or more implementations. For explanatory purposes, the process 1000 is primarily described herein with reference to the electronic device 100 and the electronic device 150 of FIG. 1. However, the process 1000 is not limited to the electronic device 100 and the electronic device 150 of FIG. 1, and one or more blocks (or operations) of the process 1000 may be performed by one or more other components and other suitable devices. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

In the example of FIG. 10, at block 1002, an electronic device (e.g., electronic device 150 may receive an audio output from another electronic device (e.g., electronic device 100). As discussed herein, the audio output from the other electronic device may be received from one or more speakers (e.g., speakers 114) of the other electronic device, at one or more microphones (e.g., microphones 116) of the electronic device. For example, the electronic device may include a handheld or wearable housing (e.g., housing 106 of FIG. 1), one or more microphones (e.g., microphones 116) disposed in the handheld or wearable housing, a display (e.g., display 110) mounted to the handheld or wearable housing, a memory (e.g., storage 1602, system memory 1604, and/or ROM 1610 of FIG. 16) disposed in the handheld or wearable housing, and/or one or more processors (e.g., processor(s) 1612) disposed in the handheld or wearable housing.

In one or more implementations, an audio output may include a sound that is generated by one or more speakers of the electronic device. The sound may include audio content. The audio content may include media content, such a song, recorded voice content, voice content of a telephone call or audio or video conference, or other recorded and/or livestreaming media content, and/or may be audio content designed and generated primarily to assist in locating the emitting electronic device. For example, audio content that is designed and generated primarily to assist in locating the emitting electronic device may include a siren sound (e.g., a sound having one or more frequencies that rise and fall over time), a Morse code distress signal, one or more tones that are emitted at frequencies corresponding to one or more resonant frequencies of the electronic device (e.g., to enhance loudness and reduce power consumption), and/or one or more chirps (which may also be referred to as pings, ticks, beeps, blips, or the like). For example, as indicated in FIG. 7, a chirp may be a burst of sound that is separated in time from one or more adjacent bursts of sound. In various use cases, between the chirps, no sound may be emitted by the electronic device, background (e.g., white) noise may be emitted by the electronic device, or one or more different chirps, pings, ticks, beeps, blips, or the like may be emitted). In various implementations, the sound may be emitted from the electronic device at one or more frequencies that are audible to a typical human ear, or may be ultrasonic sounds at frequencies higher than the range of frequencies that are audible to the human ear.

In one or more implementations, the electronic device may receive a user request (e.g., via a touch interface such as a touch-based display or other touch sensor, via a voice input to one or more microphones, such as microphone(s) 116) to locate the other electronic device, or via any other input component), and may provide (e.g., using communication circuitry 115), responsive to the user request, a trigger signal to the other electronic device, the trigger signal including an instruction to emit the audio output. In this example, in one or more use cases, a user that is wearing a smart watch may input a request to the smart watch to locate their smartphone, tablet, or other device, and the smart watch may, responsively, send a trigger signal (e.g., a wireless radio signal) to the smartphone, tablet, or other device to output the audio output. In this example, in one or more other use cases, a user that is operating a smartphone, tablet, or other device may input a request to the smartphone, tablet, or other device to locate their watch, and the smartphone, tablet, or other device may, responsively, send a trigger signal (e.g., a wireless radio signal) to the smart watch to output the audio output. As another example, the audio output may be or include an audio distress sound emitted from the other electronic device and including at least a portion having one or more frequencies between approximately twenty Hertz and approximately twenty kilohertz (e.g., a portion that is audible to a typical human ear). In this other example, in one or more use cases, a user of the other electronic device may provide a user input to the other electronic device to emit the audio distress signal if the user of the other electronic device is lost, stuck, disabled, or otherwise in distress. In this other example, in one or more use cases, the audio distress sound may include a human audible siren sound, a human audible S.O.S. sound, and an ultrasonic locator sound.

At block 1004, the electronic device may determine, based on the audio output, a location of the other electronic device. For example, receiving the audio output may include receiving a first audio output from a first speaker of the other electronic device and receiving a second audio output from a second speaker of the other electronic device, and determining the location of the other electronic device may include determining the location based on a difference (e.g., in amplitude and/or arrival time(s)) between the first audio output and the second audio output. As another example, receiving the audio signal may include receiving a first portion of the audio output with a first microphone of the electronic device and receiving a second portion of the audio output with a second microphone of the electronic device, and determining the location of the other electronic device may include determining the location based on a difference (e.g., in amplitude and/or arrival time(s)) between the first portion of the audio output and the second portion of the audio output. In another example, determining the location may include decoding a portion of the audio output to extract location information for the other electronic device from the audio output; and determining the location of the other electronic device based on the location information (e.g., as described herein in connection with FIG. 6). In another example, the electronic device may also receive time synchronization information from the other electronic device and determine the location of the other electronic device based on the audio output and the time synchronization information (e.g., as described herein in connection with FIGS. 5 and 7).

At block 1006, the electronic device may provide, for display at the electronic device, a visual indicator (e.g., visual indicator 802) of a direction from the electronic device to the location of the other electronic device (e.g., as described herein in connection with FIG. 8). In one or more implementations, other indicators, such as audio indicators or haptic indicators may be provided). The visual indicator may be an adaptive indicator that updates as the electronic device is moved and updated relative locations of the other electronic device are determined based on audio outputs from the other electronic device.

FIG. 11 illustrates a flow diagram of an example process for providing an audio output including encoded location information, in accordance with one or more implementations. For explanatory purposes, the process 1100 is primarily described herein with reference to the electronic device 100 and the electronic device 150 of FIG. 1. However, the process 1100 is not limited to the electronic device 100 and the electronic device 150 of FIG. 1, and one or more blocks (or operations) of the process 1100 may be performed by one or more other components and other suitable devices. Further for explanatory purposes, the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

In the example of FIG. 11, at block 1102, an electronic device (e.g., electronic device 100) may obtain a location of the electronic device. For example, obtaining the location may include determining the location based on GPS and/or IMU tracking data obtained at the electronic device. In one or more implementations, the location information may include a local portion (e.g., seconds of a location expressed in degrees, minutes, and seconds of longitude and/or latitude) the location of the electronic device. For example, the location may include the local portion and a regional portion (e.g., degrees or minutes of a location expressed in degrees, minutes, and seconds of longitude and/or latitude) that is omitted from the location information that is encoded in the audio output.

At block 1104, the electronic device may generate, with a speaker (e.g., a speaker 114) of the electronic device (and/or one or more additional speakers of the electronic device), an audio output that encodes location information for the location of the electronic device (e.g., as described herein in connection with FIG. 6). In one or more implementations, the electronic device may generate the audio output that encodes the location information by modulating emission times of multiple portions (e.g., multiple emitted chirps 700) of the audio output. In one or more implementations, the electronic device may generate the audio output that encodes the location information by modulating amplitudes, phases, width, or other features of multiple portions (e.g., multiple emitted chirps 700) of the audio output. In one or more implementations, the multiple portions of the audio output are emitted with one or more frequencies that are determined based on a resonance feature of the electronic device. In one or more implementations, an audio range (e.g., an entire audio range within which the audio output of the electronic device is detectable by a typical human ear or by an electronic device having comparable components to the electronic device) of the audio output is within the regional portion of the location of the electronic device.

In one or more implementations, encoding the location information into the audio output may include adding an additional “chirp” with coded (e.g., in Morse code or other code) GPS information to one or more chirps that are output as a distress signal. For example, an added chirp may be sent entirely separately from chirps and/or other audio patterns designed for detection by a human ear (e.g., a distress audio output, such as an S.O.S. message in Morse code), or can be overlapping with the chirps and/or other audio patterns designed for detection by a human ear. The location information can also, or alternatively, be encoded in the timing between the chirps and/or other audio patterns (e.g., by small variations in the emission times of the chirps, the small variations encoding the location information in a language other than Morse code, in some examples).

The encoded location information may also, or alternatively, include last known GPS location (e.g., in a use case in which a current GPS location cannot be obtained, such as due to lack of access to a GPS signal), a location confidence (e.g., based a quality and/or duration of inertial measurement unit (IMU) data that was used to track since a last known GPS location), and/or an identifier (e.g., a buddy identifier set up in advance with a buddy device of another user, such as by two hikers prior to embarking on a hike, etc.).

In one or more implementations, another electronic device (e.g., the electronic device 150) that receives the audio output including the encoded location information may emit an audio acknowledgement signal. For example, the audio acknowledgement signal may be an echo of the audio output including the encoded location information (or a portion thereof), may be output at a same or different tone as the audio output including the encoded location information, and/or may include different coded information (e.g., including location information of the receiving electronic device). As an example, relative direction information can be encoded into the audio acknowledgement signal (e.g., by increasing or decreasing an amplitude based on orientation of device). In various implementations, encoded location information can be distributed across multiple chirp cycles, and/or can be repeated with each chirp cycle or group of chirp cycles (e.g., so that a receiving device can determine a confidence metric using multiple repeated detections).

FIG. 12 illustrates a flow diagram of an example process for displaying display content from a first device at a second device using a location determined based on an audio output from first device, in accordance with one or more implementations. For explanatory purposes, the process 1200 is primarily described herein with reference to the electronic device 100 and the electronic device 150 of FIG. 1. However, the process 1200 is not limited to the electronic device 100 and the electronic device 150 of FIG. 1, and one or more blocks (or operations) of the process 1200 may be performed by one or more other components and other suitable devices. Further for explanatory purposes, the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

In the example of FIG. 12, at block 1202, an electronic device (e.g., electronic device 150) may receive an audio output from another electronic device (e.g., electronic device 100). As discussed herein, the audio output from the other electronic device may be received from one or more speakers (e.g., speakers 114) of the other electronic device, at one or more microphones (e.g., microphones 116) of the electronic device.

At block 1204, the electronic device may determine, based on the audio output, a location of the electronic device relative to the other electronic device. In one or more implementations, receiving the audio output may include receiving a first audio output (e.g., a first audio output 900) from a first speaker (e.g., a first speaker 114) of the other electronic device and receiving a second audio output (e.g., a second audio output 902) from a second speaker (e.g., a second speaker 114) at the other electronic device, and determining the location may include determining an angular location of the electronic device relative to the other electronic device based on a difference (e.g., a difference in amplitude and/or arrival time) between the received first audio output and the received second audio output (e.g., as described herein in connection with FIG. 9).

In one or more implementations, receiving the audio output may include receiving a first portion (e.g., a first portion 904) of the audio output at a first microphone (e.g., a first microphone 116) of the electronic device and receiving a second portion (e.g., a portion 906) of the audio output at a second microphone (e.g., a second microphone 116) of the electronic device, and determining the location may include determining an angular location of the electronic device relative to the other electronic device based on a difference (e.g., a difference in amplitude and/or arrival time) between the received first portion of the audio output and the received second portion of the audio output (e.g., as described herein in connection with FIG. 9).

In one or more implementations, determining the location may include determining the location based on location information that is encoded in the audio output (e.g., as described herein in connection with FIG. 6). In one or more implementations, the process 1200 may also include receiving a clock synchronization signal from the other electronic device at the electronic device, and determining the location may include determining a distance from the electronic device to the other electronic device using the audio output and the clock synchronization signal. For example, receiving the clock synchronization signal may include receiving the clock synchronization signal in a wireless electromagnetic (e.g., radio) signal (e.g., received using communications circuitry 115 of the electronic device).

At block 1206, the electronic device may receive display content from the other electronic device, the display content based on the location of the electronic device relative to the other electronic device. For example, the display content may include some or all of a desktop view of the other electronic device (e.g., including a desktop background, one or more folder and/or application icons, one or more open user interface windows, etc.).

At block 1208, the electronic device may display the display content at the electronic device. For example, the display content that is displayed the electronic device may be an extension of display content displayed at the other electronic device. For example, the display content may include at least a portion of a desktop view displayed at the other electronic device. Displaying the display content may include displaying a particular portion of the desktop view of the other electronic device that is located in the same direction (relative to another portion of the desktop view that is displayed at the other electronic device) as the direction in which the electronic device is located relative to the other electronic device (e.g., as discussed herein in connection with FIG. 9).

In one or more implementations, the process 1200 may also include providing, to the other electronic device, the location of the electronic device relative to the other electronic device. For example, the electronic device (e.g., electronic device 150) may provide the location of the electronic device relative to the other electronic device (e.g., as determined, at block 1204, using the audio output received at block 1202) to the other electronic device (e.g., electronic device 100) in a wireless electromagnetic signal (e.g., a WiFi signal or a Bluetooth signal transmitted using communications circuitry 115). In this way, the other electronic device can determine, in some examples, which portion of its own desktop view to display, and which portion is to be displayed at the electronic device based on the location information received from the electronic device. The other electronic device (e.g., electronic device 100) can then provide, to the electronic device for display at the electronic device, the portion determined, by the other electronic device, to be displayed at the electronic device. In this example, because the determination of which display content is to be displayed at which device is performed by the other electronic device, the electronic device can display, at block 1208, whichever portion of the display content is provided from the other electronic device.

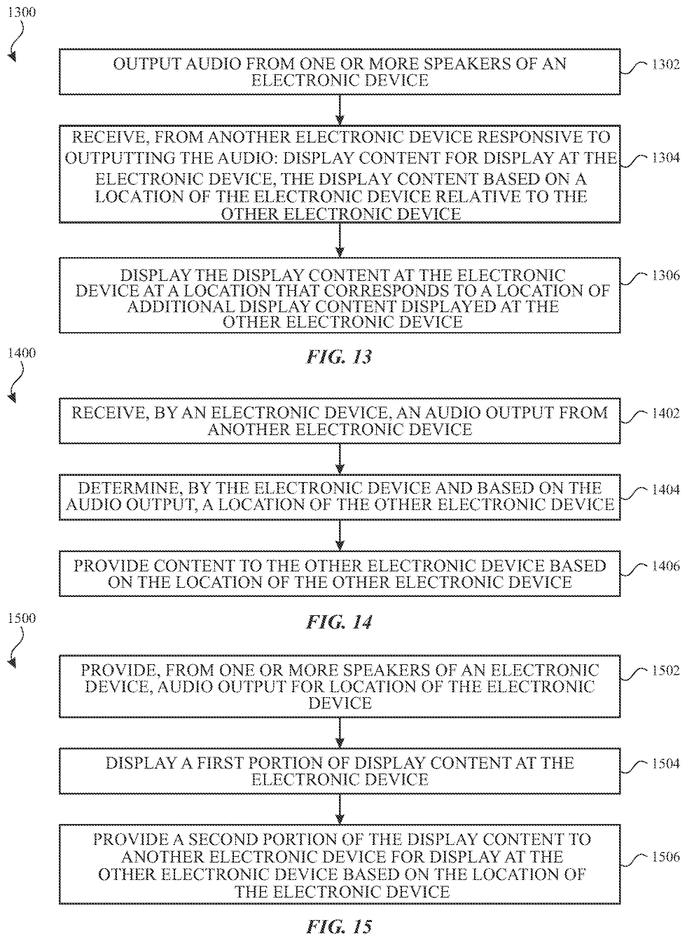

FIG. 13 illustrates a flow diagram of an example process for displaying display content from a first device, at a second device, using location information generated by the first device based on an audio output from the second device, in accordance with one or more implementations. For explanatory purposes, the process 1300 is primarily described herein with reference to the electronic device 100 and the electronic device 150 of FIG. 1. However, the process 1300 is not limited to the electronic device 100 and the electronic device 150 of FIG. 1, and one or more blocks (or operations) of the process 1300 may be performed by one or more other components and other suitable devices. Further for explanatory purposes, the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

In the example of FIG. 13, at block 1302, an electronic device (e.g., electronic device 150) may output audio from one or more speakers (e.g., speaker(s) 114) of the electronic device. In one or more implementations, outputting the audio may include outputting first audio content with a first speaker of the electronic device and outputting second audio content with a second speaker of the electronic device. For example, outputting the first audio content with the first speaker of the electronic device may include outputting the first audio content with the first speaker during a first period of time, and outputting the second audio content (e.g., the same first audio content or different audio content) with the second speaker of the electronic device may include outputting the second audio content with the second speaker of the electronic device at during a second period of time different from the first period of time. In this way, the other electronic device can distinguish which audio content is being received from which speaker of the electronic device based on the timing at which the first and second audio content are received.

As another example, outputting the first audio content with the first speaker of the electronic device may include outputting the first audio content with the first speaker during a first period of time, outputting the second audio content with the second speaker of the electronic device may include outputting the second audio content with the second speaker of the electronic device during the first period of time, and the first audio content may be different from the second audio content. In this way, the other electronic device can distinguish which audio content is being received from which speaker of the electronic device based on the content itself.

In one or more implementations, the electronic device may provide a time synchronization signal for the audio from the electronic device to the other electronic device.

At block 1304, the electronic device may receive, from another electronic device (e.g., electronic device 100) responsive to outputting the audio: display content for display at the electronic device, the display content based on a relative location of the electronic device relative to the other electronic device, the relative location being based on the audio output. For example, the other electronic device may determine, based on the audio output from the electronic device, the location of the electronic device relative to the other electronic device (e.g., as described herein in connection with any of FIGS. 2-7). The other electronic device may then determine, based on the relative location, which portion of a desktop view of the other electronic device to display at the other electronic device and which portion of the desktop view of the other electronic device to display at the electronic device. The other electronic device may then provide the display content corresponding to the portion of the desktop view of the other electronic device that was determined for display at the electronic device, to the electronic device for display at the electronic device. In one or more other examples, electronic device may receive location information from the other electronic device. For example, the location information may include instructions indicating which portion(s) of the display content to display at which location on the display of the electronic device, and may have been generated by the other electronic device based on a location of the electronic device determined, at the other electronic device, using the audio output from the electronic device (e.g., as described herein in connection with any of FIGS. 2-7).

At block 1306, the electronic device may display the display content at the electronic device at a location that corresponds to a location of additional display content displayed at the other electronic device. For example, displaying the display content may include displaying the received display content corresponding to the portion of the desktop view of the other electronic device that was determined for display at the electronic device. As another example, displaying the display content may include displaying the display content based on the location information (e.g., by determining, at the electronic device, which portion of the received display content to display based on the location information, and displaying that portion of the received display content).

FIG. 14 illustrates a flow diagram of an example process for providing content from a device to another device based on a location determined using an audio output from the other device, in accordance with one or more implementations. For explanatory purposes, the process 1400 is primarily described herein with reference to the electronic device 100 and the electronic device 150 of FIG. 1. However, the process 1400 is not limited to the electronic device 100 and the electronic device 150 of FIG. 1, and one or more blocks (or operations) of the process 1400 may be performed by one or more other components and other suitable devices. Further for explanatory purposes, the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

In the example of FIG. 14, at block 1402, an electronic device (e.g., electronic device 100) receives an audio output from another electronic device (e.g., electronic device 150). Receiving the audio output may include receiving the audio output using one or more microphones of the electronic device from one or more speakers of the other electronic device, as described herein in connection with any of FIGS. 2-6.

At block 1404, the electronic device may determine, based on the audio output, a location of the other electronic device. Determining the location may include determining the location as described in connection with any of FIGS. 2-13.

At block 1406, the electronic device may provide content to the other electronic device based on the location of the other electronic device. For example, providing the content to the other electronic device based on the location of the other electronic device may include: identifying the other electronic device as a target for the content based on the location and based on a user gesture corresponding to the location; and providing the content to the other electronic device identified as the target. For example, identifying the other electronic device as the target may include receiving a user input having a direction (e.g., a swipe in the direction, a hand gesture in the direction, an orientation of the electronic device toward the direction, or a motion of the electronic device in the direction), and identifying the other electronic device as the target by determining that the determined location of the other electronic device is in the direction of the user input. The content that is provided based on the location of the other electronic device may include photos, videos, media content, or other data.

As another example, providing the content to the other electronic device based on the location of the other electronic device may include providing display content to the other electronic device based on the location of the electronic device relative to the other electronic device (e.g., as described herein in connection with FIG. 9). For example, the display content provided to the other electronic device may be a first portion (e.g., display content B, display content C, or display content D of FIG. 9) of the display content, and the process 1400 may also include displaying a second portion (e.g., display content A) of the display content at the electronic device based on the location of the electronic device relative to the other electronic device. For example, the electronic device may determine which portion of the display content (e.g., which of display content B, display content C, or display content D of FIG. 9) is to be displayed at the other electronic device based on the location determined using the received audio output from the other device, and provide that portion of the display content to the other electronic device. The electronic device may display a remaining portion of the display content locally at the electronic device.

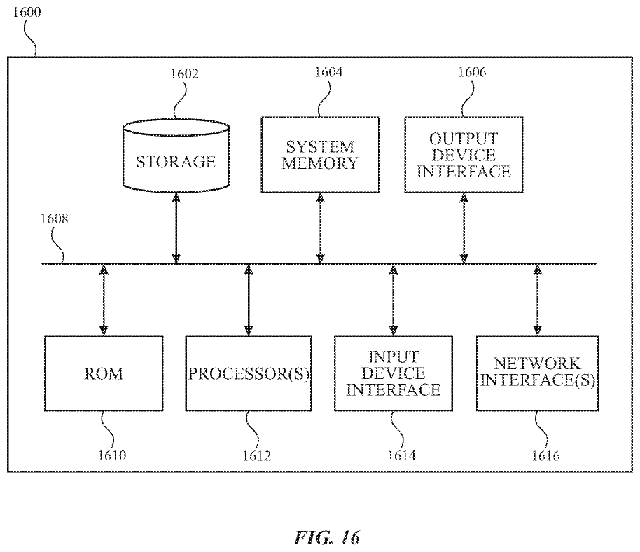

FIG. 15 illustrates a flow diagram of an example process for providing display content from a first device for display at a second device, in accordance with one or more implementations. For explanatory purposes, the process 1500 is primarily described herein with reference to the electronic device 100 and the electronic device 150 of FIG. 1. However, the process 1500 is not limited to the electronic device 100 and the electronic device 150 of FIG. 1, and one or more blocks (or operations) of the process 1500 may be performed by one or more other components and other suitable devices. Further for explanatory purposes, the blocks of the process 1500 are described herein as occurring in serial, or linearly. However, multiple blocks of the process 1500 may occur in parallel. In addition, the blocks of the process 10500 need not be performed in the order shown and/or one or more blocks of the process 1500 need not be performed and/or can be replaced by other operations.

In the example of FIG. 15, at block 1502, an electronic device (e.g., electronic device 100) may provide, from one or more speakers (e.g., speaker(s) 114) of the electronic device, audio output for location of the electronic device (e.g., for locating the electronic device). For example, providing the audio output for location of the electronic device from the one or more speakers may include outputting first audio content from a first speaker of the one or more speakers; and outputting second audio content from a second speaker of the one or more speakers. For example, the first audio content may be the same as the second audio content, outputting the first audio content from the first speaker may include outputting the first audio content from the first speaker during a first period of time, and outputting the second audio content from the second speaker may include outputting the second audio content from the second speaker during a second period of time different from the first period of time. As another example, the first audio content may be different from the second audio content, and outputting the second audio content from the second speaker may include outputting the second audio content from the second speaker concurrently with outputting the first audio content from the first speaker.

In one or more implementations, the process 1500 may also include providing a time synchronization signal for the audio output from the electronic device to the other electronic device (e.g., as described herein in connection with FIGS. 5 and 7).

At block 1504, the electronic device may display a first portion (e.g., display content A of FIG. 9) of display content at the electronic device. At block 1506, the electronic device may provide a second portion (e.g., display content B, display content C, or display content D of FIG. 9) of the display content to another electronic device (e.g., electronic device 150) for display at the other electronic device based on the location of the electronic device (e.g., as described herein in connection with FIG. 9). For example, the electronic device (e.g., electronic device 100) may receive, responsive to outputting the audio at block 1502), a location of the other electronic device (e.g., electronic device 150) from the other electronic device (e.g., in a wireless electromagnetic signal, such as a WiFi signal or a Bluetooth signal transmitted using communications circuitry 115). The electronic device may determine the first portion for display at the electronic device and the second portion for display at the other electronic device based on the received location of the other electronic device relative to the electronic device, and then provide the determined second portion to the other electronic device for display at that other electronic device (e.g., as described herein in connection with FIG. 9).

Various examples are described herein in which the electronic device 100 outputs audio that can be used by another electronic device (e.g., the electronic device 150) to locate the electronic device 100 and in which the electronic device 100 is implemented as a computer such as a computer that is integrated into a display such as a computer monitor, a laptop computer, a media player, a gaming device, a navigation device, a computer monitor, a television, a headphone, an earbud, or a wearable device such as a smart watch. In one or more other implementations, the electronic device 100 may be implemented in or as a vehicle, such as a car, a bus, a train, a bicycle, a scooter, or the like that may include one or more speakers and be configured to output audio that can be used by another electronic device to locate the vehicle (e.g., to determine a range and/or angular location of the vehicle relative to the other electronic device) and/or that includes one or more microphones that can be used to determine a location of another electronic device based on audio received from the other electronic device. In one or more implementations, the electronic device 100 may be a personal electronic device that is associated with a particular user account and/or user. In one or more other implementations, the electronic device 100 may be implemented as a public device such as a traffic signal, a crosswalk signal, an alarm or alert device, or any other public device having one or more speakers configured to output audio that can be used by another electronic device to locate the public device (e.g., determine a range and/or angular location of the public device relative to the other electronic device) and/or that includes one or more microphones that can be used to determine a location of another electronic device based on audio received from the other electronic device. For example, such public devices may be distributed throughout a city or a building. As examples, public devices that can provide audio for determining a location of the public device and/or that can determine a location of another device using received audio can be used to provide location-specific safety alerts, evacuation directions, advertising, traffic control, and/or other location-specific services to one or more other electronic devices that are within an audio range of the public devices.

As described above, aspects of the present technology may include the gathering and use of data available from specific and legitimate sources for providing user information in association with processing audio and/or non-audio signals. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for determining a location of an electronic device. Further, other uses for personal information data that benefit the user are also contemplated by the present disclosure.

For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of determining a location of an electronic device, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 16 illustrates an electronic system 1600 with which one or more implementations of the subject technology may be implemented. The electronic system 1600 can be, and/or can be a part of, one or more of the electronic device 100 or the electronic device 150 shown in FIG. 1. The electronic system 1600 may include various types of computer readable media and interfaces for various other types of computer readable media. The electronic system 1600 includes a bus 1608, one or more processing unit(s) 1612, a system memory 1604 (and/or buffer), a ROM 1610, a permanent storage device 1602, an input device interface 1614, an output device interface 1606, and one or more network interfaces 1616, or subsets and variations thereof.

The bus 1608 collectively represents all system, peripheral, and chipset buses that communicatively connect the numerous internal devices of the electronic system 1600. In one or more implementations, the bus 1608 communicatively connects the one or more processing unit(s) 1612 with the ROM 1610, the system memory 1604, and the permanent storage device 1602. From these various memory units, the one or more processing unit(s) 1612 retrieves instructions to execute and data to process in order to execute the processes of the subject disclosure. The one or more processing unit(s) 1612 can be a single processor or a multi-core processor in different implementations.

The ROM 1610 stores static data and instructions that are needed by the one or more processing unit(s) 1612 and other modules of the electronic system 1600. The permanent storage device 1602, on the other hand, may be a read-and-write memory device. The permanent storage device 1602 may be a non-volatile memory unit that stores instructions and data even when the electronic system 1600 is off. In one or more implementations, a mass-storage device (such as a magnetic or optical disk and its corresponding disk drive) may be used as the permanent storage device 1602. ROM 1610, storage 1602, and/or system memory 1604 may store executable code (e.g., executable by the processor(s) 1612 for one or more applications, such as a telephony application, a mail application, a browser application, a media player application, a video conferencing application, a recording application, a messaging application, a calendar application, a fitness application, a mapping application, a payment processing application, a device location application, a word processing application, a presentation application, and/or any other end-user application.

In one or more implementations, a removable storage device (such as a flash drive, and its corresponding disk drive) may be used as the permanent storage device 1602. Like the permanent storage device 1602, the system memory 1604 may be a read-and-write memory device. However, unlike the permanent storage device 1602, the system memory 1604 may be a volatile read-and-write memory, such as random access memory. The system memory 1604 may store any of the instructions and data that one or more processing unit(s) 1612 may need at runtime. In one or more implementations, the processes of the subject disclosure are stored in the system memory 1604, the permanent storage device 1602, and/or the ROM 1610. From these various memory units, the one or more processing unit(s) 1612 retrieves instructions to execute and data to process in order to execute the processes of one or more implementations.

The bus 1608 also connects to the input and output device interfaces 1614 and 1606. The input device interface 1614 enables a user to communicate information and select commands to the electronic system 1600. Input devices that may be used with the input device interface 1614 may include, for example, microphones, alphanumeric keyboards and pointing devices (also called “cursor control devices”). The output device interface 1606 may enable, for example, the display of images generated by electronic system 1600. Output devices that may be used with the output device interface 1606 may include, for example, printers and display devices, such as a liquid crystal display (LCD), a light emitting diode (LED) display, an organic light emitting diode (OLED) display, a flexible display, a flat panel display, a solid state display, a projector, a speaker or speaker module, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 16, the bus 1608 also couples the electronic system 1600 to one or more networks and/or to one or more network nodes through the one or more network interface(s) 1616. In this manner, the electronic system 1600 can be a part of a network of computers (such as a LAN, a wide area network (“WAN”), or an Intranet, or a network of networks, such as the Internet. Any or all components of the electronic system 1600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Various functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, and any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

In accordance with aspects of the subject technology, an electronic device is provided that includes a handheld or wearable housing; one or more microphones disposed in the handheld or wearable housing; a display mounted to the handheld or wearable housing; a memory disposed in the handheld or wearable housing; and one or more processors disposed in the handheld or wearable housing and configured to: receive, using the one or more microphones, an audio output from another electronic device; determine, based on the audio output, a location of the other electronic device; and display, using the display of the electronic device, a visual indicator of a direction from the electronic device to the location of the other electronic device.

In one or more implementations, the one or more processors are further configured to receive, at the electronic device, a user request to locate the other electronic device; and provide, responsive to the user request, a trigger signal to the other electronic device, the trigger signal comprising an instruction to emit the audio output. The audio output may include an audio distress sound emitted from the other electronic device and including at least a portion having one or more frequencies between approximately twenty Hertz and approximately twenty kilohertz. The one or more processors may also be configured to: receive the audio output by receiving a first audio output from a first speaker of the other electronic device and receiving a second audio output from a second speaker of the other electronic device, and determine the location of the other electronic device based on a difference between the first audio output and the second audio output. The one or more processors may also be configured to: receive the audio output by receiving a first portion of the audio output with a first microphone of the electronic device and receiving a second portion of the audio output with a second microphone of the electronic device, and determine the location of the other electronic device based on a difference between the first portion of the audio output and the second portion of the audio output. The one or more processors may be configured to determine the location by: decoding a portion of the audio output to extract location information for the other electronic device from the audio output; and determining the location of the other electronic device based on the location information. The one or more processors may also be configured to: receive time synchronization information from the other electronic device; and determine the location of the other electronic device based on the audio output and the time synchronization information. The one or more processors may also be configured to: receive the audio output while operating the electronic device in a low power mode of operation; and responsive to receiving the audio output, switch the electronic device to a higher power mode of operation for determining the location of the other electronic device.

In accordance with other aspects of the subject technology, an electronic device is provided that includes a speaker; a memory; and one or more processors configured to: obtain a location of the electronic device; and generate, with the speaker, an audio output that encodes location information for the location of the electronic device. The one or more processors may also be configured to generate the audio output that encodes the location information by modulating emission times of multiple portions of the audio output. The multiple portions of the audio output may be emitted with one or more frequencies that are determined based on a resonance feature of the electronic device. The location information may include a local portion the location of the electronic device. The location may include the local portion and a regional portion that is omitted from the location information that is encoded in the audio output. An audio range of the audio output may be within the regional portion of the location of the electronic device.

In accordance with other aspects of the subject technology, a method is provided that includes obtaining, by an electronic device, a location of the electronic device; and generating, with a speaker of the electronic device, an audio output that encodes location information for the location of the electronic device. Generating the audio output that encodes the location information may include modulating emission times of multiple portions of the audio output. The multiple portions of the audio output may be emitted with one or more frequencies that are determined based on a resonance feature of the electronic device. The location information may include a local portion the location of the electronic device. The location may include the local portion and a regional portion that is omitted from the location information that is encoded in the audio output. An audio range of the audio output may be within the regional portion of the location of the electronic device.

As used in this specification and any claims of this application, the terms “computer”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or design.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An electronic device, comprising:
a handheld or wearable housing;
one or more microphones disposed in the handheld or wearable housing;
a display mounted to the handheld or wearable housing;
a memory disposed in the handheld or wearable housing; and
one or more processors disposed in the handheld or wearable housing and configured to:
receive, using the one or more microphones, an audio output from another electronic device;
determine, based on the audio output, a location of the other electronic device; and
display, using the display of the electronic device, a visual indicator of a direction from the electronic device to the location of the other electronic device.

2. The electronic device of claim 1, wherein the one or more processors are further configured to:
receive, at the electronic device, a user request to locate the other electronic device; and
provide, responsive to the user request, a trigger signal to the other electronic device, the trigger signal comprising an instruction to emit the audio output.

3. The electronic device of claim 1, wherein the audio output comprises an audio distress sound emitted from the other electronic device and including at least a portion having one or more frequencies between approximately twenty Hertz and approximately twenty kilohertz.

4. The electronic device of claim 1, wherein the one or more processors are configured to:
receive the audio output by receiving a first audio output from a first speaker of the other electronic device and receiving a second audio output from a second speaker of the other electronic device, and
determine the location of the other electronic device based on a difference between the first audio output and the second audio output.

5. The electronic device of claim 1, wherein the one or more processors are configured to:
receive the audio output by receiving a first portion of the audio output with a first microphone of the electronic device and receiving a second portion of the audio output with a second microphone of the electronic device, and
determine the location of the other electronic device based on a difference between the first portion of the audio output and the second portion of the audio output.

6. The electronic device of claim 1, wherein the one or more processors are configured to determine the location by:
decoding a portion of the audio output to extract location information for the other electronic device from the audio output; and
determining the location of the other electronic device based on the location information.

7. The electronic device of claim 1, wherein the one or more processors are further configured to:
receive time synchronization information from the other electronic device; and
determine the location of the other electronic device based on the audio output and the time synchronization information.

8. The electronic device of claim 1, wherein the one or more processors are configured to:
receive the audio output while operating the electronic device in a low power mode of operation; and
responsive to receiving the audio output, switch the electronic device to a higher power mode of operation for determining the location of the other electronic device.

9. An electronic device comprising:
a speaker;
a memory; and
one or more processors configured to:
obtain a location of the electronic device; and
generate, with the speaker, an audio output that encodes location information for the location of the electronic device.

10. The electronic device of claim 9, wherein the one or more processors are configured to generate the audio output that encodes the location information by modulating emission times of multiple portions of the audio output.

11. The electronic device of claim 10, wherein the multiple portions of the audio output are emitted with one or more frequencies that are determined based on a resonance feature of the electronic device.

12. The electronic device of claim 9, wherein the location information comprises a local portion the location of the electronic device.

13. The electronic device of claim 12, wherein the location comprises the local portion and a regional portion that is omitted from the location information that is encoded in the audio output.

14. The electronic device of claim 13, wherein an audio range of the audio output is within the regional portion of the location of the electronic device.

15. A method, comprising:
obtaining, by an electronic device, a location of the electronic device; and
generating, with a speaker of the electronic device, an audio output that encodes location information for the location of the electronic device.

16. The method of claim 15, generating the audio output that encodes the location information comprising modulating emission times of multiple portions of the audio output.

17. The method of claim 16, wherein the multiple portions of the audio output are emitted with one or more frequencies that are determined based on a resonance feature of the electronic device.

18. The method of claim 15, wherein the location information comprises a local portion the location of the electronic device.

19. The method of claim 18, wherein the location comprises the local portion and a regional portion that is omitted from the location information that is encoded in the audio output.

20. The method of claim 19, wherein an audio range of the audio output is within the regional portion of the location of the electronic device.
